(19) United States
(12) Patent Application Publication
(10) Pub. No.: US 2006/0007178 A1
(43) Pub. Date: Jan. 12, 2006

(54) Electronic device having an imporoved user interface

(76) Inventor: Scott Davis, Vancouver (CA)

Correspondence Address: PERMAN & GREEN, 425 POST ROAD, FAIRFIELD, CT, 06824, US

(21) Appl. No.: 10/886,136

(22) Filed: Jul. 7, 2004

(51) Int. Cl. G09G 5/00

(52) U.S. Cl. 345/173

(57) ABSTRACT

A portable, handheld, electronic device (301) has a touch-sensitive display (302), and a virtual keypad (304) that is displayed on the touch-sensitive display (302). The virtual keypad (304) has a position on the touch-sensitive display (302) and is extended in two mutually essentially orthogonal directions for a first and a second extension length. The device (301) also has control means (305) which are adapted to move the virtual keypad (304) on the display (302).

### TECHNICAL FIELD

The present invention relates to handheld, portable, electronic devices having a graphical user interface based on a touch-sensitive display and in particular to mobile radio communications terminals having a graphical user interface based on a touch-sensitive display.

### TECHNOLOGICAL BACKGROUND OF THE INVENTION

Some of the mobile phones and Personal Digital Assistants, PDAs currently available on the market that have touch-sensitive displays are often quite large as a large display is often preferred for providing a more advanced graphical user interface. These devices often rely on the user using both hands to operate the device, one hand for supporting the device and the other hand for making the actual inputs, unless the device is supported in some other way, like laying on a table for example.

Having a large display or screen often make the device quite large and the size of the device makes it hard to handle the device with only one hand in situations requiring this, like when a user is carrying something in one hand and needs to make a call without stopping or if the user is suffering from some handicap or injury preventing him or her from using both hands. In these situations the users might support the device in the palm of one hand and with his fingers and use his thumb to do the actual input like punching in the numbers of a telephone number on a virtual ITU-T keypad presented on the touch-sensitive display. However, the thumb might not reach all of the available keys presented on the touch-sensitive display without the user changing the position of the device, which in turn increases the risk of dropping and damaging the device and it also becomes cumbersome for the user to constantly have to shift the device to input various characters and letters or choosing options.

Some mobile telephones with touch-sensitive displays have a flap with mechanical keys that interact with the touch-sensitive display as the flap is folded over the display and the keys are pressed, thus providing a substitute for a common hard key ITU-T keypad. These flaps with associated mechanical keys are, however, quite expensive and also quite prone to breakage or other damage.

### SUMMARY OF THE INVENTION

In view of the above, an objective of the invention is to solve or at least reduce the problems discussed above and to provide an improved portable, handheld electronic device compared to the prior art.

Generally, the above objective is achieved by a portable device according to the attached independent claims. Thus, a first aspect of the invention is a portable, handheld, electronic device comprising a touch-sensitive display and a virtual keypad being displayable on said touch-sensitive display wherein, the virtual keypad is movable for easier access by a user. By moving the virtual keypad according to a user's whishes the user can more easily reach the desired virtual keys on the virtual keypad.

In an embodiment the virtual keypad is extended in two mutually orthogonal directions for a first and a second extension length, wherein, one of the extension lengths is changeable. In this way the virtual keypad's shape can be changed to better fit in the position where the user wants to place the virtual keypad, and the virtual keypad can be positioned very close to an edge of the display with all virtual keys still visible and accessible.

In another embodiment the moving of the virtual keypad and changing of at least one of the extensions lengths is done simultaneously. This will enable the user to swiftly move and, if needed, correspondingly resize the virtual keypad and seeing the result without any intermediate actions which will make the repositioning and resizing quick and simple, easy to learn and intuitive to use.

In an embodiment the moving is controllable by the user using control means. The presence of visible control means representations on the display further makes the invention easy and intuitive to learn and use.

In a further embodiment the control means are represented on the touch-sensitive display in the form of at least one geometrical figure. Having graphical representations is a cheap and simple way of presenting the control means and their functionality to the user.

In one embodiment the control means are operable through at least one mechanical key on said device. By using a mechanical key, space on the touch-sensitive display can be used for other purposes, to offer more freedom of movement for the virtual keypad and to possibly present crucial information to the user.

In an embodiment the control means are represented on the touch-sensitive display as the virtual keypad. By letting the virtual keypad be the representation of the control means no extra space on the touch-sensitive display is needed and no extra key is needed and the user does not have to move his finger to access the control means as it is most likely already poised over the virtual keypad during typing.

In a further embodiment the control means are adapted to move the position of the virtual keypad in whichever direction the virtual keypad is moved by the user by depressing, dragging and subsequently releasing the virtual keypad. This is a very intuitive and easy-to-use solution, as well as very cheap to implement, of how to provide a movement control feature for the virtual keypad to the user which only requires very few finger movements.

In another embodiment the device is a mobile radio communications terminal. The adoption of the invention in a mobile terminal provides ample opportunity for a user to use the full range of features offered by a mobile phone having a touch screen-based graphical user interface while still being able to operate it with one hand only, as certain situations might require this and as this is the preferred way of using a mobile radio communcations terminal.

In another embodiment the device is a personal digital assistant. The adoption of the invention in a PDA provides ample opportunity for a user to use the full range of features offered by a PDA having a touch screen-based graphical user interface while still being able to operate it with one hand only, as certain situations might require this.

According to another aspect of the invention the objectives above are achieved by a portable, handheld, electronic device comprising a touch-sensitive display, a virtual keypad being displayable on said touch-sensitive display, said virtual keypad having a position on the touch-sensitive display and being extended in two mutually essentially orthogonal directions for a first and a second extension length, and control means wherein, the control means are adapted to move the virtual keypads position on the display. By moving the virtual keypad according to a user's whishes the user can more easily reach the desired virtual keys on the virtual keypad.

According to a further aspect of the invention the objectives above are achieved by a portable, handheld, electronic device comprising control means, a touch-sensitive display, and a virtual keypad having one or more virtual keys each having a size, said virtual keypad being displayable on said touch-sensitive display said virtual keypad having a position and being extended in two mutually orthogonal extension directions for a first and a second extension length, wherein, said control means are adapted to move said virtual keypad's position on said touch-sensitive display in at least one of said orthogonal extension directions. By moving the virtual keypad according to the user's whishes, the user can more easily reach the desired virtual keys on the virtual keypad.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, member, step, etc]” are to be interpreted openly as referring to at least one instance of said element, device, component, means, mebmer, step, etc., unless explicitly stated otherwise.

### BRIEF DESCRIPTION OF THE DRAWINGS

Some embodiments of the present invention will now be described in more detail, reference being made to the enclosed drawings:

FIG. 1 is a schematic illustration of a telecommunications system, in which the present invention may be applied.

FIG. 2 is a schematic block diagram illustrating a mobile terminal of FIG. 1 in more detail.

FIG. 3a is a schematic view of a portable, handheld device having a touch-sensitive display with a virtual keypad displayed upon it according to the invention.

FIG. 3b is a schematic view of a portable, handheld device having a touch-sensitive display with a virtual keypad displayed upon it wherein, the virtual keypad has been moved according to the invention.

FIG. 4a is a schematic view of a portable, handheld device having a touch-sensitive display with a virtual keypad displayed upon it according to the invention.

FIG. 4b is a schematic view of a portable, handheld device having a touch-sensitive display wherein, the virtual keypad has been moved and altered in one direction according to the invention.

FIG. 4c is a schematic view of a portable, handheld device having a touch-sensitive display wherein, the virtual keypad has been moved-and altered in two directions according to the invention.

### DETAILED DISCLOSURE OF EMBODIMENTS

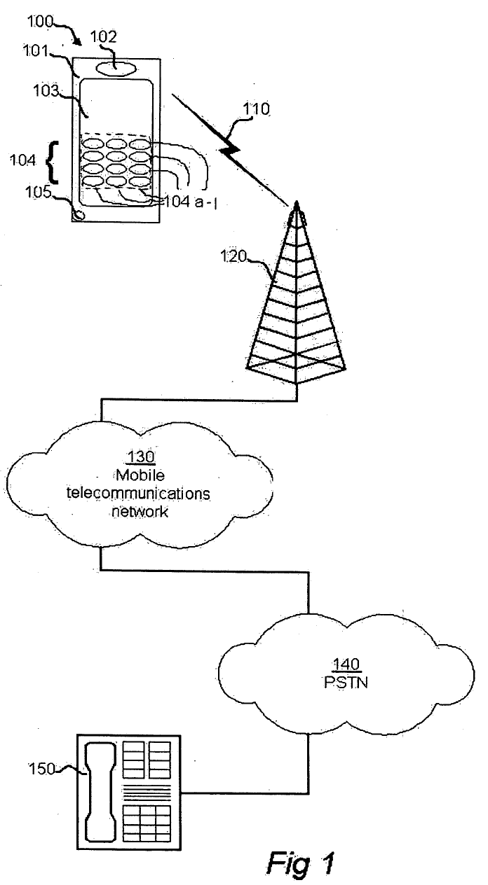

Before giving a detailed description of the embodiments shown in FIGs X,Y and Z, FIG. 1 will provide an overview of a telecommunication system and a mobile terminal used therein, as one example of an electronic device in which the present invention may be included.

In the telecommunication system of FIG. 1, a mobile terminal 100 is connected across a wireless communication link 110 to a base station 120 of a mobile telecommunications network 130. The mobile telecommunications network 130 is connected to another telecommunications network 140, a public switched telephone network (PSTN). In this way, a user of the mobile terminal 100 may communicate with another user of a stationary telephone 150. The mobile terminal may be any commercially available device—such as a mobile (cellular) telephone, a portable digital assistant (PDA) or a communicator which is adapted for any known mobile telecommunications system, such as GSM, UMTS or D-AMPS.

As is well known in the art, the mobile terminal 100 comprises an apparatus housing 101, a loudspeaker 102, a touch screen display 103, a virtual keypad 104, indicated with a dashed line rectangle in the figure for clarity and this rectangle might not be present in an implemented embodiment, with virtual keys, and a microphone 105. In addition, but not shown in FIG. 1, the mobile terminal 100 comprises various components, such as a built-in or external antenna, a radio transceiver, a speech encoder/decoder, a channel encoder/decoder, a processing device (CPU), an electronic memory, and various segments of software code, which are stored in the memory and are executed by the processing device so as to perform the various functions and operations of the mobile terminal 100.

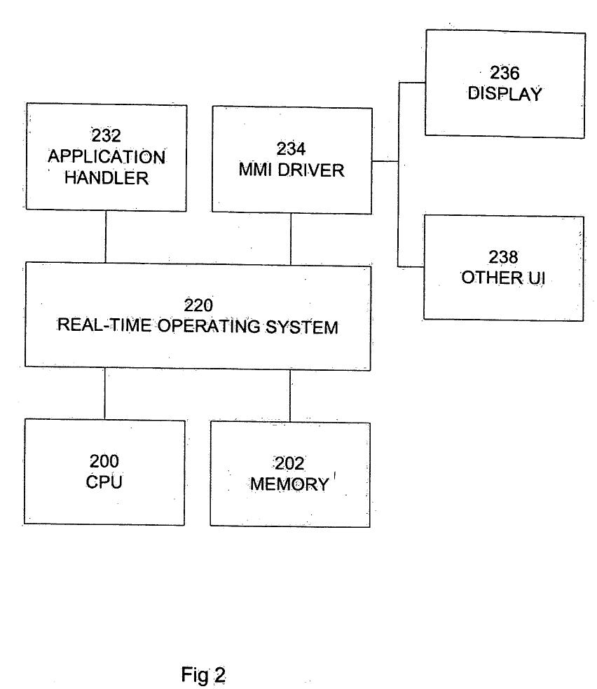

FIG. 2 illustrates one embodiment of a mobile terminal according to the invention. A controller 200 is responsible for the overall operation of the mobile terminal and is preferably implemented by any commercially available CPU (“Central Processing Unit”), DSP (“Digital Signal Processor”) or any other electronic programmable logic device. The controller 200 has associated electronic memory 202 such as RAM memory, ROM memory, EEPROM memory, flash memory, or any combination thereof. The memory 202 is used for various purposes by the controller 200, one of them being for storing data and program instructions for various software in the mobile terminal. The software includes a real-time operating system 220, man-machine interface (MMI) drivers 234, an application handler 232 as well as various applications. The MMI drivers 234 cooperate with conventional MMI or input/output (I/O) devices, including a display 236 and various mechanical keys 238 such as volume control as well as various other I/O devices such as a microphone, a speaker, a vibrator, a joystick, a ringtone generator, an LED indicator, etc. As is commonly known, a user may operate the mobile terminal through the man-machine interface thus formed.

As a user presses on one of the virtual keys presented on the display information concerning which key is pressed is sent to the MMI drivers 834 which informs the CPU of which action should be taken and after the action has been calculated possibly bu the application handler 323 its result is presented to the user through the drivers either on the display 236 or for example through the speaker depending on the action taken.

As is well known, the touch-sensitive display can be used to display virtual keys which can be operated by the user by pressing down on top of them on the screen, often with a stylus. The keys 104a-l have an assigned position on the display and a corresponding functionality. As a keypress is detected on or in a specified area close to a virtual keys 104a-l position, the corresponding function is performed or executed by the CPU. Functions can be more complex, like starting an application, or simple like inputting a character. The corresponding function is often displayed on the graphical representation of the virtual keys 104a-l on the display. The area around the virtual key's position is usually equal to the size of the virtual key itself so that the virtual key's representation determines the area corresponding to the function. As is known, a virtual key can have different functionality depending on where it is pressed, and the specified pressing area is then most often smaller than the virtual key's representation, so that more areas on the same virtual key can be defined. The virtual keys 104a-l can also be grouped together in a virtual keypad having a position and the positions of the individual virtual keys 104a-l comprised in this virtual keypad 104 are then calculated relative to the virtual keypad's 104 position. Normally the virtual keys 104a-l are positioned or distributed evenly within the virtual keypad 104 in a matrix structure extending in two directions, vertically and horizontally for an extension length, that can be different for the two directions, so that there is enough space for the virtual keys 104a-l within the virtual keypad.

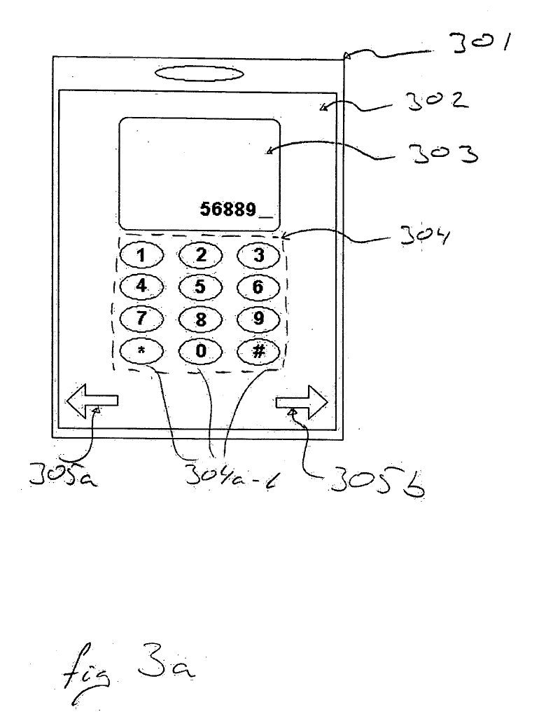

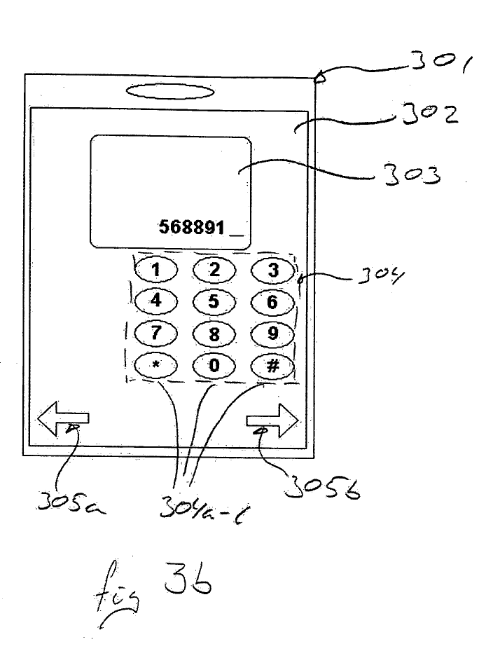

FIG. 3a shows a portable, handheld device 301, such as a mobile telephone or a PDA, according to the invention. Below the virtual keypad 304 there are two arrows 305a, b displayed on the touch-sensitive display pointing 302 contra-directionally to the sides of the device 301. These arrows 305a-b are movement control indicators or representations and act as a user interface for the movement control of the virtual keypad. In a display window 303 the user has already typed in the number “56889”. If a user is using the device with his right hand only he probably has some problems reaching or accessing the virtual keys 304a-d on the lefthand side of the display 302. According to the invention, if the user wants to input the character ‘1’, but can not reach the characters on the keys 304a-d displayed on the lefthand side of the display 302, the user can simply press on the righthand arrow 305b which will then activate a control function which moves the entire virtual keypad 304 to the right and repositions the virtual keypad 304 and the virtual keys 304a-l therein correspondingly. FIG. 3b shows the device 301 after the virtual keypad 304 has been moved, wherein the user has now been able to reach the lefthand side virtual keys 304a-d and has inputted the character ‘1’ as shown in the display window 303.

Should the user shift hands or possibly start using the device with both hands again, the virtual keypad 304 can easily be moved back to either the lefthand side or to the center again by pressing the left arrow 305a.

Naturally, the virtual keypad 304 could also be adapted to be moved up and down, and also both left, right and up, down.

The virtual keypad 304 could be moved either in discrete steps or continuously as long as either of the movement control indicators 305a-b is being pressed.

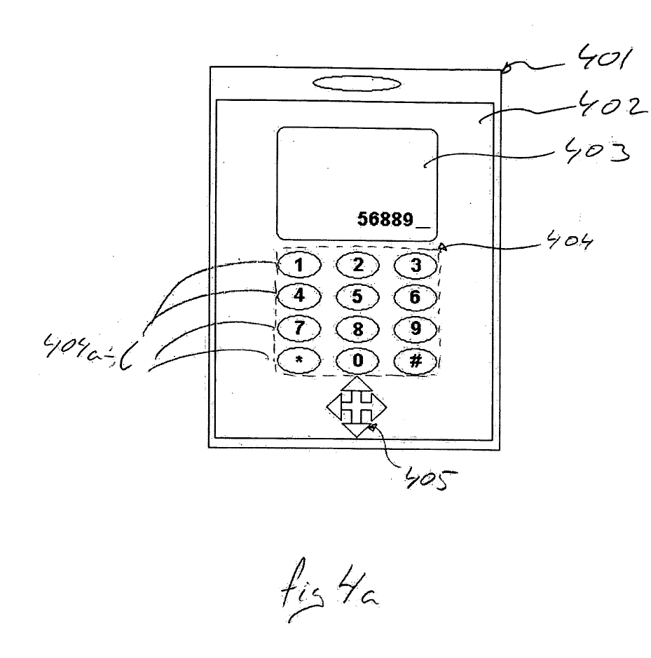

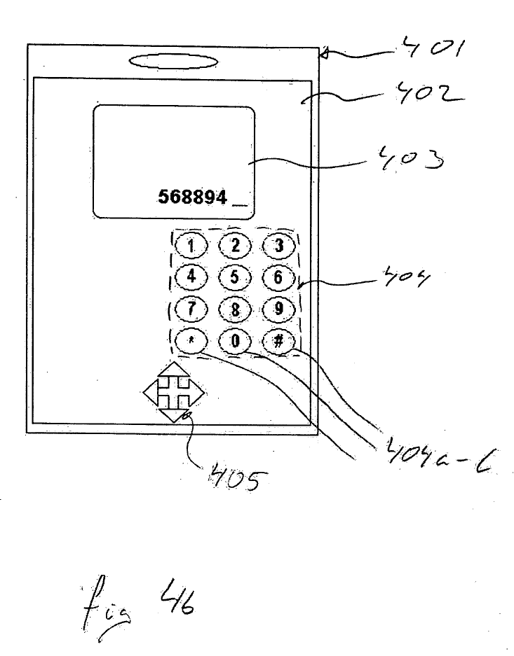

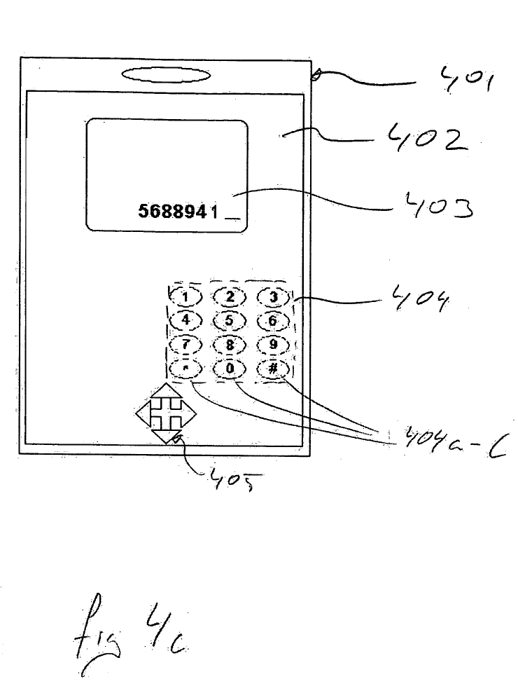

In FIG. 4a a portable, handheld device 401, such as a mobile telephone or a PDA according to the invention is shown. Below the virtual keypad 404 there is a four-way arrow 405 pointing upwards, downwards, to the left and to the right of the display 402 as seen when facing the device 401. The number “56889” has been entered and is displayed in the display window 403. If the user can not, as above, reach the lefthand virtual keys 404a-d, the user presses the arrow 405 on the hand pointing to the right thus moving the virtual keypad 404 and repositioning it to the right. If the user has small fingers and wants to move the lefthand virtual keys 404a-d far to the right, wherein the whole virtual keypad 404 might not fit anymore and a part of the virtual keypad 404 might be cut off and the virtual keys 404i-l would not be displayed. To enable the user to follow up with inputting either of the symbols on these virtual keys 404i-l without moving the virtual keypad 404 again, the virtual keypad's 404 length in the horizontal direction could be made shorter so that the virtual keypad fits within the display 402. The respective virtual keys 404a-l in the virtual keypad would then possibly have to be made smaller as well and their positions would also be recalculated according to the new position and size of the virtual keypad 404. As seen in FIG. 4b the virtual keypad 404 has been moved to the right, the horisontal extension has been reduced and the virtual keys 404a-l been made smaller accordingly. The user can now easily reach the lefthand virtual keys 404a-d while still having access to the whole virtual keyboard. The user has now inputted the character ‘4’ and the number displayed is “568894”. If the user still has problems reaching the top row of virtual keys, namely ‘1’, ‘2’ and ‘3’ on virtual keys 404a, 404e and 404i, the user can now press the downwards pointing hand of the four-way arrow 405, wherein the virtual keypad 404 will be moved down as far as the user wants it and if needed reduced in length or size in the vertical direction as well. The virtual keys 404a-l will also be resized and their positions recalculated if needed. In this way the lefthand keys 404a-d can be moved further to the right without the virtual keypad 404 extending beyond the display area 402, in which case some of the keys 404a-l, especially the righthand keys 404i-l, would not be visible on the display nor accessible.

FIG. 4c shows a device 3c according to the invention where a virtual keypad 404 has been moved to the lower righthand side of the display 402 and wherein, the virtual keypad has been reduced in size both vertically and horizontally. The user now has no problems reaching the virtual key 404a for character ‘1’, and the number “5688941” has been successfully entered using only one hand and without shifting or changing grip although all characters could not be reached at first.

The virtual keypad 404 could be moved back to its original position, to the center or to any of the corners or sides of the display for easier access by the user, and this could be done either in discrete steps or continuously as long as the movement control indicator 405 is pressed in either direction.

It could also be possible to have a reset function of the movement control indicator. For example by pressing in the middle of the four-way arrow 405 the virtual keypad 404 is centered on the display 402 in its original size.

It should be clear to a person skilled in the art that if the position of the virtual keys 404a-l and their sizes are defined relative to the position and size of the virtual keypad 404, the recalculation can be made very simple.

The moving and altering of the shape could either be done individually, simultaneously or by first only moving and then as the virtual keypad comes near a display edge, reducing the virtual keypad in size as it is moved even closer to the edge.

It should also be clear that the movement control indicators or representations could be any gemotercial figure such as: two contra-directional arrows, a bi-directional arrow, two mutually orthogonal bi-directional arrows such as a cross arrow or four-way arrow, pointing triangles, rombs or special characters such as ‘<’ and ‘>’ The movement control indicators could also be in the form of a sliding bar or a 2-dimensional sliding bar where the virtual keypad is moved according to how the the bar is slid back and forth or back, forth, up and down.

The movement control indicators could also be a movement detection field, wherein the user moves a finger and the virtual keypad is moved in the direction the finger was moved. One example would be to have a rectangle displayed under the virtual keypad, and when a user wanted to move the virtual keypad he would simply stroke his thumb or finger over the rectangle area and the virtual keypad would be moved in the same direction as the rectangle was stroked. The rectangle could have any shape, and a narrow one would intuitively suggest movement in one degree of freedom (left and right) and a wider rectangle would suggest movement in two degrees of freedom (up, down, left and right).

The virtual keypad could also be controlled by mechanical keys on the device, either dedicated ones or as an additional feature of one of the keys commonly seen in mobile phones, PDAs or other portable, handheld devices, such as volume keys, in which case no extra keys are needed.

The virtual keypad could also be moved by pressing down on the virtual keypad representation and then dragging it to either side and letting go, whereby the virtual keypad and the associated virtual keys would be moved and, if needed, reshaped to the new position. Possibly the user would have to press down and hold the finger pressed for a short time before moving the virtual keypad to differentiate the move action from normal keypresses that might be done shakily (for instance when standing in a rocking subway train) or to differentiate the move action from various possible shortpress and longpress actions.

It should be clear that the invention is applicable to other handheld, portable, electronic devices, that are meant or designed to be carried and operated in one or two hands leisurely without needing other support, having a graphical user interface based on a touch screen.

It should also be clear that the invention is equally applicable to different key layouts and that the 12-key ITU-T layout used in the examples above is just an example of a common key layout used in mobile phones.

If there is any other virtual input or display element on either side of the virtual keypad this could be moved to the other side of the virtual keypad to make more room for movement as the virtual keypad is moved towards the other element. For instance, if a battery or power status bar is displayed on the right hand side of the screen and the user has problems reaching the virtual keys and therefore moves the virtual keypad to the right, the user does not really need to have the pwer status bar on the right hand side and would, in fact, benefit from having the battery status bar moved to the left-hand side of the display thus leaving more space on the right-hand side of the display for the virtual keypad.

The invention has mainly been described above with reference to a few embodiments. However, as is readily appreciated by a person skilled in the art, other embodiments than the ones disclosed above are equally possible within the scope of the invention, as defined by the appended patent claims.

1. A portable, handheld, electronic device (301) comprising
a touch-sensitive display (302),
a virtual keypad (304) being displayable on said touch-sensitive display (302),
said virtual keypad (304) having a position on the touch-sensitive display (302) and
being extended in two mutually essentially orthogonal directions for a first and a second extension length,
and control means (305), wherein the control means (305) are adapted to move the virtual keypad's (304) position on the touch-sensitive display (302).

2. A portable, handheld, electronic device according to claim 1 wherein, the control means are also adapted to alter at least one of the extension lengths.

3. A portable, handheld, electronic device according to claim 2 wherein, the control means are adapted to move the position of the virtual keypad and alter at least one of the extension lengths simultaneously.

4. A portable, handheld, electronic device according to claim 1 wherein, the device is a mobile radio communications terminal.

5. A portable, handheld, electronic device according to claim 1 wherein, the device is a personal digital assistant.

6. A portable, handheld, electronic device according to claim 1 wherein, the control means have a user interface which includes at least one geometrical figure displayable on said touch-sensitive display.

7. A portable, handheld, electronic device according to claim 1 wherein, the control means have a user interface which includes mechanical keys.

8. A portable, handheld, electronic device according to claim 1 wherein, the control means have a user interface which includes a graphical representation of said virtual keypad on said touch-sensitive display.

9. A portable, handheld, electronic device according to claim 8 wherein, the control means are adapted to move the position of the virtual keypad in whichever direction the virtual keypad is moved by a user pressing down on, dragging and subsequently releasing the virtual keypad.

10. A portable, handheld, electronic device (301) comprising
a touch-sensitive display (302) and
a virtual keypad (304) being displayed on said touch-sensitive display (302) wherein the virtual keypad (304) is movable.

11. A portable, handheld, electronic device according to claim 10 wherein, the virtual keypad being extended in two mutually orthogonal directions for a first and a second extension length wherein, at least one of the extension lengths is changeable.

12. A portable, handheld, electronic device according to claim 11 adapted for simultaneous moving of the position of the virtual keypad and changing of at least one of the extensions lengths.

13. A portable, handheld, electronic device according to claim 10 wherein, the moving being controllable by a user using control means.

14. A portable, handheld, electronic device according to claim 13 wherein, the control means have a user interface which includes at least one geometrical figure displayable on said touch-sensitive display.

15. A portable, handheld, electronic device according to claim 13 wherein, the control means have a user interface which includes mechanical keys.

16. A portable, handheld, electronic device according to claim 13 wherein, the control means have a user interface which includes a graphical representation of said virtual keypad on said touch-sensitive display.

17. A portable, handheld, electronic device according to claim 16 wherein, the control means are adapted to move the position of the virtual keypad in whichever direction the virtual keypad is moved by the user pressing down on, dragging and subsequently releasing the virtual keypad.

18. A portable, handheld, electronic device according to claim 10 wherein,said device is a mobile radio communications terminal.

19. A portable, handheld, electronic device according to claim 10 wherein, said device is a personal digital assistant.

20. A portable, handheld, electronic device (301) comprising
control means (305),
a touch-sensitive display (302)
a virtual keypad (304), having
one or more virtual keys (304a-l) each having a size,
said virtual keypad (304) being displayable on said touch-sensitive display (302) said virtual keypad (304) having a position and being extended in two mutually orthogonal extension directions for a first and a second extension length, wherein said control means (305) is adapted to move said virtual keypad's position on said touch-sensitive display (302) in at least one of said extension directions.

21. A portable, handheld, electronic device according to claim 20 wherein, the control means being adapted to alter at least one of the extension lengths of said virtual keypad.

22. A portable, handheld, electronic device according to claim 21 wherein said virtual keypad has one or more virtual keys each having a size that depends on at least one of the two extension lengths, and wherein said control means is adapted to change said size according to said alteration of said at least one of the extension lengths.

23. A portable, handheld, electronic device according to claim 21, wherein said touch-sensitive display has a display area and wherein said control means is adapted to change at least one of said extension lengths so that the virtual keypad does not extend beyond said display area.

24. A portable, handheld, electronic device according to claim 21, wherein said control means being adapted to simultaneously move the virtual keypad and alter at least one of the extension lengths.

25. A portable, handheld, electronic device according to claim 20, wherein the control means have a user interface which includes at least one geometrical figure displayable on said touch-sensitive display.

26. A portable, handheld, electronic device according to claim 20, wherein said control means being operable through at least one mechanical key on said device.

27. A portable, handheld, electronic device according to claim 20, wherein the control means have a user interface which includes a graphical representation of said virtual keypad on said touch-sensitive display.

28. A portable, handheld, electronic device according to claim 27, wherein the control means are adapted to move the position of the virtual keypad in whichever direction the virtual keypad is moved by a user pressing down on, dragging and subsequently releasing the virtual keypad.

29. A portable, handheld, electronic device according to claim 20, wherein said device is a mobile radiofrequency communication terminal.

30. A portable, handheld, electronic device according to claim 20, wherein said device is a personal digital assistant.

31. A portable, handheld, electronic device according to claim 20, wherein said control means are adapted to reset the virtual keypad's posistion.

32. A portable, handheld, electronic device according to claim 21, wherein said control means are adapted to reset at least one of the virtual keypad's extentions lengths.

33. A portable, handheld, electronic device according to claim 21, wherein said control means are adapted to reset the virtual keypad's posistion and at least one of the extension lengths simultaneously.

34. A portable, handheld, electronic device according to claim 25, wherein said geometrical figure is one of: two contra-directional arrows, a bi-directional arrow, two mutually orthogonal bi-directional arrows, pointing triangles, rombs or a special character.

35. A portable, handheld, electronic device according to claim 20, wherein said control means have a user interface which includes a sliding bar being displayable on said touch-sensitive display.

36. A portable, handheld, electronic device according to claim 20, wherein the control means have a user interface which includes a movement detection field.

37. A portable, handheld, electronic device according to claim 20, wherein said control means are adapted to also move an object being displayed when the virtual keypad is being moved on a position that lies in the direction the virtual keypad is being moved to another position on the display.
